(19) United States
(12) Patent Application Publication
(10) Pub. No.: US 2024/0054294 A1
(43) Pub. Date: Feb. 15, 2024

(54) MULTILINGUAL CONTENT MODERATION USING MULTIPLE CRITERIA

(71) Applicant: SRI International, Menlo Park, CA (US)

(72) Inventors: Karan SIKKA, Robbinsville, NJ (US); Meng YE, Lawrenceville, NJ (US); Ajay DIVAKARAN, Monmouth Junction, NJ (US)

(21) Appl. No.: 18/233,658

(22) Filed: Aug. 14, 2023

Related U.S. Application Data
(60) Provisional application No. 63/397,487, filed on Aug. 12, 2022.

(51) Int. Cl. G06F 40/40; G06F 40/35

(52) U.S. Cl. CPC G06F 40/40; G06F 40/35

(57) ABSTRACT

A method, apparatus and system for moderating multilingual content data, for example, presented during a communication session include receiving or pulling content data that can include multilingual content, classifying, using a first machine learning system, the content data by projecting the content data into a trained embedding space to determine at least one English-language classification for the content data, and determining, using a second machine learning system, if the content data violates at least one predetermined moderation rule, wherein the second machine learning system is trained to determine from English-language classifications determined by the first machine learning system if the content data violates moderation rules. In some embodiments, the method apparatus and system can further include prohibiting a presentation of the content data related to the at least one English-language classification determined to violate the at least one predetermined moderation rule.

### CROSS-REFERENCE TO RELATED APPLICATIONS

This application claims benefit of U.S. Provisional Patent Application Ser. No. 63/397,487 filed Aug. 12, 2022, which is herein incorporated by reference in its entirety.

### GOVERNMENT RIGHTS IN THIS INVENTION

This invention was made with U.S. Government support under Contract Number HR0011-22-9-0024 awarded by the Defense Advanced Research Projects Agency. The U.S. Government has certain rights in the invention.

### BACKGROUND OF THE INVENTION

### Field of the Invention

Embodiments of the present invention generally relate to content moderation, and more specifically to content moderation using a multilingual dataset and moderation model.

### Description of the Related Art

Content moderation is the process of flagging content based on pre-defined platform rules. Being able to moderate user-generated content is critical for online social media platforms. Several platforms employ human moderators to monitor user content to prevent the spread of misinformation, adverse effects of hateful speech, fraud, etc. The moderators' task is to remove improper content and/or suspend users posting such content. However, reviewing and moderating each user comment is practically infeasible due to limited resources, especially during time-critical and largescale events. More importantly, such moderation work can cause damage to moderators' mental health due to burnout from extensive amounts of work and exposure to harmful content.

Recently, researchers have put effort into collecting hate speech or offensive language datasets from social platforms such as Twitter and YouTube, or a mixture of those platforms. These datasets contain annotations of hateful speech and are used to train NLP systems to remove harmful comments. Such work is typically referred to as Offensive Language Identification (OLI). Such system, however, are not adequate for meeting the challenges of content moderation since 1) moderation decisions are based on violation of rules, which subsumes detection of offensive speech, and 2) such rules often differ across communities which requires an adaptive solution.

### SUMMARY OF THE INVENTION

Embodiments of the present principles provide methods, apparatuses and systems for moderating multilingual content data presented, for example, during a communication session.

In some embodiments, a method for moderating multilingual content data includes receiving or pulling content data that can include multilingual content, classifying, using a first machine learning system, the content data by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar, and determining, using a second machine learning system, if the content data violates at least one predetermined moderation rule, wherein the second machine learning system is trained to determine from English-language classifications determined by the first machine learning system if the content data violates moderation rules.

In some embodiments, the method can further include prohibiting a presentation of the content data related to the at least one English-language classification determined to violate the at least one predetermined moderation rule.

In some embodiments the method can further include presenting semantic parameters related to the determined at least one English-language classification to at least one participant of the communication session.

In some embodiments, the semantic parameters include at least one of an intent of the received or pulled content data, an emotion of the received or pulled content data, an offensiveness of the received or pulled content data, an abuse level of the received or pulled content data, or a topic of the received or pulled content data.

In some embodiments of the present principles, the content data includes English-language content data and the at least one English-language classification is determined for the English-language content data using the English language content data.

In some embodiments of the present principles, the content data comprises non-English-language content data and similar English-language content data is determined for the non-English-language content data by projecting the non-English-language content data into the embedding space and at least one English-language classification is determined for the non-English-language content data using the determined similar English language content data.

In some embodiments of the present principles, the content data is presented during a communication session and the method further includes clustering participants of the communication session based on semantic characteristics of respective content data posted to the communication session by each of the participants.

In some embodiments of the present principles, the method can further include soliciting information from at least one source of the received or pulled content data to assist in determining an accuracy of the at least one English-language classification determined for the received or pulled content data.

In some embodiments, an apparatus for moderating multilingual content data includes a processor and a memory accessible to the processor, the memory having stored therein at least one of programs or instructions executable by the processor. When the programs or instructions are executed by the processor, the apparatus is configured to receive or pull content data that can include multilingual content, classify, using a first machine learning system, the content data by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar, and determine, using a second machine learning system, if the content data violates at least one predetermined moderation rule, wherein the second machine learning system is trained to determine from English-language classifications determined by the first machine learning system if the content data violates moderation rules.

In some embodiments, the apparatus is further configured to prohibit a presentation of the content data related to the at least one English-language classification determined to violate the at least one predetermined moderation rule.

In some embodiments, a non-transitory computer readable storage medium has stored thereon instructions that when executed by a processor perform a method for moderating multilingual content data, the method including receiving or pulling content data that can include multilingual content, classifying, using a first machine learning system, the content data by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar, and determining, using a second machine learning system, if the content data violates at least one predetermined moderation rule, wherein the second machine learning system is trained to determine from English-language classifications determined by the first machine learning system if the content data violates moderation rules.

In some embodiments, the method can further include prohibiting a presentation of the content data related to the at least one English-language classification determined to violate the at least one predetermined moderation rule.

Various advantages, aspects and features of the present disclosure, as well as details of an illustrated embodiment thereof, are more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a high-level block diagram of a multilingual moderation system in accordance with an embodiment of the present principles.

FIG. 2 depicts a graphic representation of a second training stage of a language machine learning system of the language module of the multilingual moderation system of FIG. 1 in accordance with an embodiment of the present principles.

FIG. 3 depicts a graphic functional diagram of an operation of a multilingual moderation system in accordance with an embodiment of the present principles.

FIG. 4A depicts a graphic representation of a first embodiment of a graphical user interface (GUI) which can be implemented to communicate with a user of a multilingual moderation system of the present principles in accordance with an embodiment of the present principles.

FIG. 4B depicts a graphic representation of a second embodiment of a graphical user interface (GUI) which can be implemented to communicate with a user of a multilingual moderation system of the present principles in accordance with an embodiment of the present principles.

FIG. 4C depicts a graphic representation of a third embodiment of a graphical user interface (GUI) which can be implemented to communicate with a user of a multilingual moderation system of the present principles in accordance with an embodiment of the present principles.

FIG. 5 depicts a flow diagram of a method for multilingual content data moderation in accordance with an embodiment of the present principles.

FIG. 6 depicts a high-level block diagram of a computing device suitable for use with embodiments of a multilingual moderation system in accordance with an embodiment of the present principles.

FIG. 7 depicts a high-level block diagram of a network in which embodiments of an imaging and control system in accordance with the present principles can be implemented.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to content moderation using multilingual datasets, language models and moderation models. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific content data posted during specific communication sessions, embodiments of the present principles can be applied to substantially any content data posted during substantially any communication session.

In some embodiments of the teachings of the present principles herein, the term multilingual and phrase multilingual content data are used to describe and define content data that can include data including but not limited to audio, visual, and textual content data that can include English-language content data, non-English-language (foreign) content data, and/or both English-language content data and non-English-language (foreign) content data.

Throughout the teachings herein, reference is made to content data and content data parameters being similar dependent upon how close content data or contend data projected into an embedding space is to content data or content data parameters embedded in the embedding space. It should be understood that the concept of closeness in an embedding space is dependent upon a granularity desired in a system. For example, in various embodiments of the present principles a threshold distance can be determined to define closeness in an embedding space and any projected content data within the determined threshold of embedded content data and/or content data parameters can be defined as being similar to the embedded content data and/or content data parameters. For example, in such embodiments, non-English-language (foreign language) content data projected into an embedding space of the present principles described herein, can be determined to be similar and or equivalent to English-language content data embedded in the embedding space if the projected non-English-language content data is within a predetermined threshold distance of English-language content data embedded in the embedding space, for example, during a training phase of the embedding space. Similarly, English-language content data and/or non-English-language content data projected into the embedding space can be determined to comprise specific classifications if the projected English-language content data and/or and non-English-language content data are within a predetermined threshold distance of classifications embedded in the embedding space, for example, during a training phase of the embedding space.

Throughout this disclosure the terms learning model, machine learning (ML) model, ML algorithm, and ML classifier are used interchangeably to describe, in one embodiment, an ML system/process that can be trained to recognize/detect and distinguish between various types of languages of content and to convert non-English-language content into English-language content, and in another embodiment, an ML system/process that can be trained to recognize/detect and distinguish between content that violates moderation rules and includes at least one of offensive and hate content.

Online content moderation involves detection of comments (phrases and/or words) that violate community rules in addition to those that are offensive. For example, moderators will often remove comments that are self-promoting, spamming, or off-topic because they do not provide useful information and are harmful for the communication environment (e.g., “I can help you, see my Youtube channel”). In such cases, a model trained to only detect offensive language and/or hate speech will likely fail to detect the rules violation. Embodiments of the present principles provide methods, apparatuses, and systems for providing multilingual content moderation that take into account at least explicit community rules, for example written by moderators, as well as offensive and hateful content.

Embodiments of the present principles can be provided to actively moderate content data from, for example, social media platforms to foster positive dialog and discourage harmful behaviors such as disinformation campaigns, bullying etc. In some embodiments of the present principles, social media platforms can include Facebook and Twitter. Other social media platforms can include enterprise platforms that are restricted to certain users. Embodiments of the present principles can apply to any media platforms in which individuals or groups are posting content data.

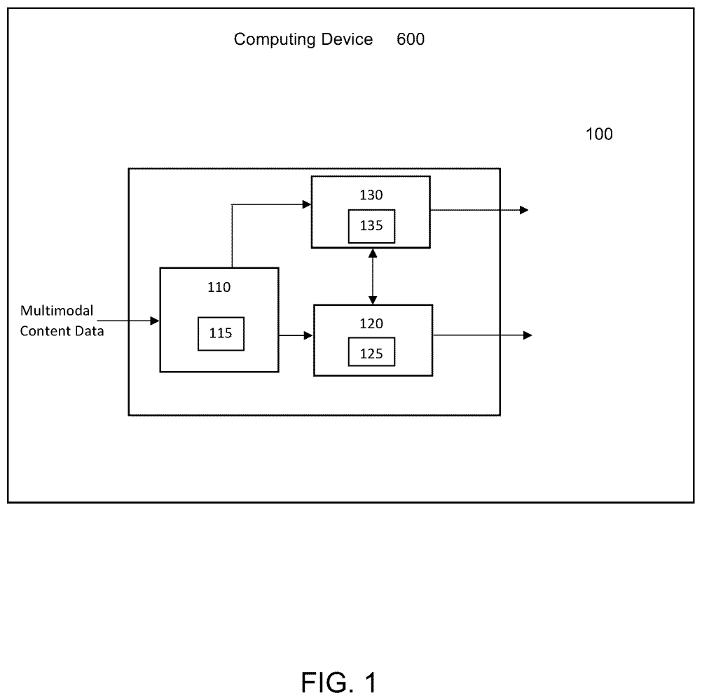

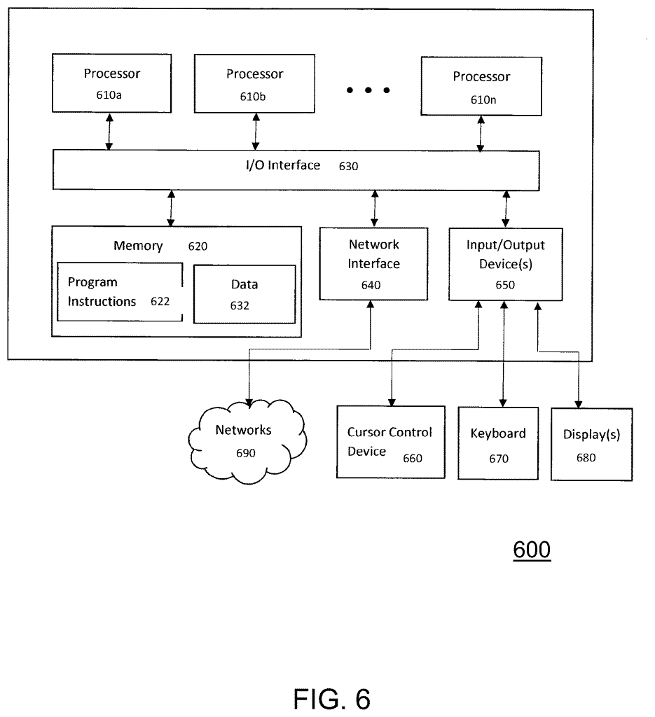

FIG. 1 depicts a high-level block diagram of a multilingual moderation system 100 in accordance with an embodiment of the present principles. The multilingual moderation system 100 of FIG. 1 illustratively includes a language module 110, a moderation control module 120, and an optional reporting module 130. In the embodiment of the multilingual moderation system 100 of FIG. 1, the language module 110 includes an optional, language machine learning system 115, the moderation control module includes a moderation machine learning system 125, and the optional reporting module includes an optional semantics machine learning system 135. As depicted in FIG. 1, embodiments of a multilingual moderation system of the present principles, such as the multilingual moderation system 100 of FIG. 1, can be implemented via a computing device 600 in accordance with the present principles (described in greater detail below with respect to FIG. 6).

In embodiments of the multilingual moderation system 100 of FIG. 1, multilingual content data can be received and/or acquired (pulled) by the language module 110. That is, in some embodiments the language module can receive and/or pull content data from, for example, a communication session in many different languages. In some embodiments of the present principles, the multilingual content data can include multilingual content data from a social media site.

In some embodiments of the present principles, the language module 110 processes received and/or acquired (pulled) multilingual content data by determining English-equivalent content data for non-English-language (foreign language) content data and by determining at least one classification for the content data. For example, in such embodiments the language machine learning system 115 of the language module 110 of the multilingual moderation system 100 of FIG. 1 can be trained to determine English-equivalent content data for non-English content data and to determine at least one classification for the content data using an embedding space.

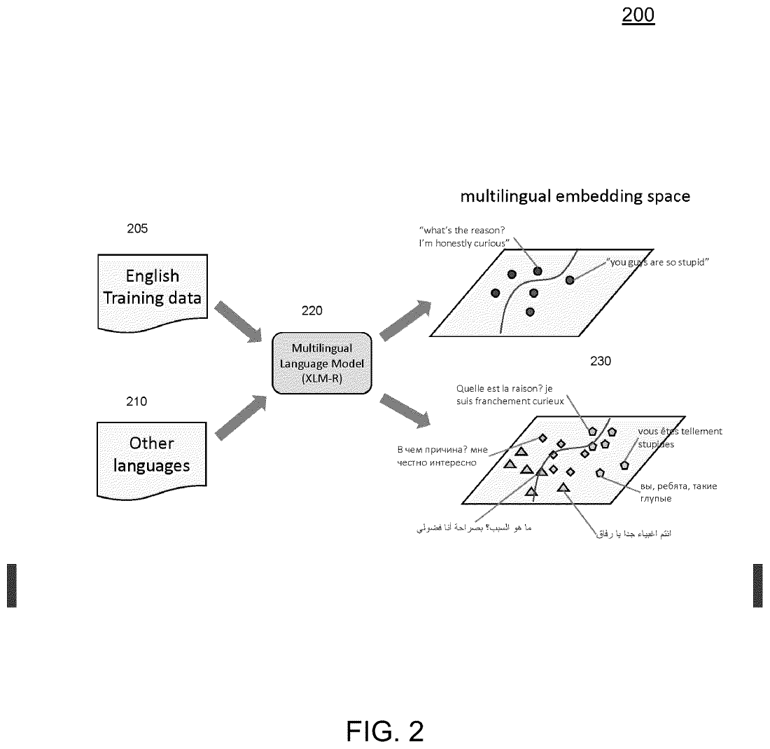

For example, FIG. 2 depicts a graphic representation of a first training stage 200 of a multilingual language learning and classification model/algorithm 220 of the language machine learning system 115 of the language module 110 using an embedding space 230 in accordance with an embodiment of the present principles. In the embodiment of FIG. 2, the multilingual language learning and classification model/algorithm 220 receives English-language content data 205 (e.g., English-language words and/or phrases) and similar non-English-language content data 210 (e.g., Foreign-language words and/or phrases). That is, in some embodiments the multilingual language learning and classification model/algorithm 220 of the language machine learning system 115 of the language module 110 of FIG. 1 can be trained using a plurality (e.g., hundreds, thousands, millions, etc.) of instances of labeled content data in which the training data comprises a plurality of labeled content data of non-English-language content data and similar English-language content data to train a multilingual language learning and classification model/algorithm of the present principles to determine English-language equivalents of non-English-language content data. For example and as depicted in the embodiment of FIG. 2, feature vectors of non-English-language content data and corresponding similar English-language content data can be embedded in the embedding space 230 for a plurality of non-English-language content data and corresponding similar English-language content data such that words and/or phrases in different languages that are similar occur closer to each other in the embedding space 230, and non-similar words and phrases are further apart in the embedding space 230.

Once the embedding space is trained as described above, English-language equivalent (similar) content data for received/acquired non-English-language content data can be determined using the trained multilingual language learning and classification model/algorithm 220 of the language machine learning system 115 of the language module 110 by projecting the received/acquired non-English-language content data into the embedding space. For example, in some embodiments a feature vector of the received/acquired non-English-language content data can be projected into the embedding space 230, once trained, and a closest English-language content data vector embedded in the embedding space can be determined to be an English-language equivalent content data of the projected non-English-language content data feature vector.

In some embodiments, in a second training stage the multilingual language learning and classification model/algorithm 220 of the language machine learning system 115 of the language module 110 can be trained to determine at least one English-language classification for English-language content data and for English-language equivalent (similar) content data determined for received/acquired non-English language content data. That is, in some embodiments the multilingual language learning and classification model/algorithm 220 of the language machine learning system 115 of the language module 110 of FIG. 1 can be trained using a plurality (e.g., hundreds, thousands, millions, etc.) of instances of labeled content data in which the training data comprises a plurality of labeled content data of classification labels for English-language content data to train a multilingual language learning and classification model/algorithm of the present principles to determine at least one English-language classification for English-language content data and English-equivalent (similar) content data determined for non-English content data. For example, during training, a human can determine at least one English-language classification for English-language phrases and/or words. In some embodiments of the present principles, the classifications can include at least a word or phrase known to have a specific meaning or semantic characteristics, including but not limited to at least one of an intent of specific English-language phrases and/or words, an emotion of specific English-language phrases and/or words, an offensiveness of specific English-language phrases and/or words, an abuse level of specific English-language phrases and/or words, a topic of specific English-language phrases and/or words and the like. Such phrases and/or words can be known to moderators and moderation rules can be based on such known phrases and/or words. In some embodiments, during training, feature vectors for such classifications can be determined and embedded in the embedding space 230. In some embodiments, determined classifications for English-language phrases and/or words can be embedded in the embedding space 230 such that the classifications determined for English-language phrases and/or words are close in the embedding space to the specific English-language phrases and/or words for which the classifications were determined.

For example, in one embodiment a moderator module of the present principles can be trained to recognize that the phrase “You are stupid” violates moderation rules. In accordance with some embodiments of the present principles, an embedding space of the present principles can include a classification of “You are stupid”. After training of the embedding space, when a phrase “You are silly” is received, the phrase “You are silly” can be projected into the embedding space, as described above, and the phrase “You are silly” can be assigned a classification of “You are stupid” based on how close the phrase “You are silly” is in the embedding space to the embedded classification of “You are stupid”. As such, when a moderator module of the present principles receives the classification of the phrase “You are silly”, the moderator module can determine that the phrase “You are silly” violates the moderation rule associated with the phrase “You are stupid”, which was determined to violate a moderation rule.

In general, once trained to determine at least one classification for English-language phrases and/or words, the multilingual language learning and classification model/algorithm 220 of the language machine learning system 115 of the language module 110 can determine at least one classification for received/acquired multilingual content data. For example, when English-language phrases and/or words are received/acquired by the language model 110, such English-language phrases and/or words can be projected into the embedding space 230 and a closest, embedded classification(s) to the English-language phrases and/or words projected in the embedding space can be determined to be a classification for the received/acquired English-language phrases and/or words. In instances in which non-English-language (foreign language) phrases and or words are received/acquired by the language model 110, such non-English-language phrases and/or words can be projected into the embedding space 230 and a closest, embedded English-language phrase and/or word can be determined to be a similar (equivalent) English-language phrase and/or word for the received/acquired non-English-language phrase and/or word. A classification(s) for the non-English-language (foreign language) phrase and or word can then be determined as a closest, embedded classification to the determined similar (equivalent) English-language phrase and/or word for the received/acquired non-English-language phrase and/or word. For example, in an embodiment in which an English-language phrase of “You are a Republican idiot” is received/acquired by a language module of the present principles, such as the language module 110 of FIG. 1, the language model can classify the English-language phrase as being both offensive and as comprising the topic of being political.

Alternatively, in some embodiments, a multilingual language learning and classification model/algorithm of the present principles, such as the multilingual language learning and classification model/algorithm 220 of the language machine learning system 115, is not trained to determine English-language equivalent (similar) content data for received/acquired non-English-language content data using the embedding space 230. Instead, in such embodiments, a language module of the present principles, such as the language module 110 of FIG. 1, can include a pre-trained multilingual language model (not shown), such as XLM-RoBERTa to determine English-language equivalent (similar) content data for received/acquired non-English-language content data. In such embodiments, a multilingual language learning and classification model/algorithm of the present principles only needs to be trained to determine at least one classification for English-language phrases and/or words as described in the previous embodiment as a second training stage.

Referring back to the multilingual moderation system 100 of FIG. 1, in either embodiment described above, for example whether English-language equivalent (similar) content data is determined for non-English-language content data using the multilingual language learning and classification model/algorithm 220 of the language machine learning system 115 of the language module 110 or a pre-trained multilingual language model (not shown) such as XLM-RoBERTa, the at least one classification determined for received/acquired content data is communicated to the moderation control module 120. At the moderation control module 120, the determined classification for the received/acquired content data can be used to determine if the received/acquired content data violates moderation rules of, for example, a communication session from which the content data was received/acquired. That is, at the moderation control module 120, at least one classification determined for respective content data is evaluated to determine if the content data should or should not be allowed, for example, to be posted on a social media site. In some embodiments of the present principles, the moderation machine learning system 125 of the moderation control module 120 can be trained to recognize classifications for content data that violate moderation policies for a particular application and as such to determine that the associated content data should not be allowed/presented and/or should be prohibited from presentation. In some embodiments of the present principles, prohibiting content data from presentation can include blocking content data from being posted and/or alerting a user that such content data should not be posted.

Because the at least one classification is determined for content data received by the moderation control module 120 from the language module 110 that is always in English, despite the language of origin of received/acquired content data at the language module 110, the moderation machine learning system 125 of the moderation control module 120 can be trained using English training data. Such “English-only” training enables the entire system of the present principles, such as the multilingual moderation system 100 of FIG. 1, to be scalable and tractable since the complexity of the system remains independent of the number of languages. Furthermore, English language content is plentiful and easily available which makes the training of the moderation machine learning system 125 much simpler compared to that required for full multilingual training with multiple languages.

In some embodiments of the present principles, the moderation machine learning system 125 of the moderation control module 120 can be trained to recognize classifications of content data that violate moderation rules and as such content data for which a respective classification was determined should not be presented/posted and/or should be prohibited from presentation. That is, in some embodiments, the moderation control module 120 can receive classifications for content data having labels identifying the classifications for the content data that has been deemed by a human moderator as complying with moderation rules and having labels identifying classifications for content data that does not comply with moderation rules for a specific platform (e.g., application). The labeled classifications of content data received by the moderation control module 120 can be used to train the moderation machine learning system 125 to recognize/detect and distinguish between classifications for content data that comply with moderation rules and classifications for content data the violate moderation rules for a specific platform.

In some embodiments, the moderation machine learning system 125 can include a multi-layer neural network comprising nodes that are trained to have specific weights and biases. In some embodiments, the moderation machine learning system 125 employs artificial intelligence techniques or machine learning techniques to analyze received classifications of content data to identify whether or not the classifications of the content data comply with moderation rules. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data content.

As described above, during training, the moderation machine learning system 125 of the moderation control module 120 can be trained using a plurality (e.g., hundreds, thousands, millions, etc.) of instances of labeled classifications for content data identifying classifications for content data that comply with moderation rules and classifications of content data that violate moderation rules to train a moderation machine learning system of the present principles, such as the moderation machine learning system 125 of the moderation control module 120, to recognize/detect and distinguish between classifications for content that comply with moderation rules and classifications for content data that do not comply with moderation rules of a specific platform. Moderation machine learning systems of the present principles can be trained, as described above, for a plurality of platforms having respective rules.

In some embodiments of the present principles, a moderation control module of the present principles, such as the moderation control module 120 of FIG. 1, can provide information about which moderation guidelines were violated by particular classifications of content data. In some embodiments, the moderation control module 120 of the multilingual moderation system 100 of FIG. 1 can represent a moderation guideline being violated as a latent variable h and model the probability distribution of output as a conditional distribution PP(yy|xx, h), where yy represents the output and xx represents a classification of content data. In some embodiments, the probability distribution PP(yy|xx, h) can be modeled as another linear layer on top of the moderation machine learning system/model 125 the moderation control module 120. In some embodiments of the present principles, the training of the moderation machine learning system/model 125 is converted into an inference-based learning problem and expectation-maximization can be used to learn the moderation machine learning system/model 125. As a result, the moderation machine learning system/model 125 can flag content data as complying with moderation rules or not and also provide insight into the moderation guideline being violated. Alternatively or in addition, in some embodiments, the moderation machine learning system/model 125 can be trained to recognize which moderation guidelines have been violated using training data including labeled classifications for content data having information as to which moderation guidelines are violated by the labeled classifications for the content data.

Once trained, a moderation machine learning system of the present principles, such as the moderation machine learning system 125 of the moderation control module 120 of FIG. 1, can be used to determine using the determined classifications if received content data violates moderation rules to determine if the content data received from, for example a content poster on a social media platform, should be presented, for example, to another user of the social media platform or if such content should be prohibited from posting/presentation. For example, in some embodiments of the present principles the moderation control module 120 can prohibit/block a display of content data determined to violate at least one moderation rule of, for example, a communication session by, for example, not forwarding such content data to a display device of the computing device 600 (described in FIG. 6 below) and/or to the reporting module 130.

In some embodiments of the present principles, the processed content data from the language module 110 can be communicated directly or through the moderation control module 120 to the optional reporting module 130. The reporting module 130 can be used to include determined classifications for received/acquired content data in a presentation to be presented to at least a provider of the content data and/or an intended receiver of the content data.

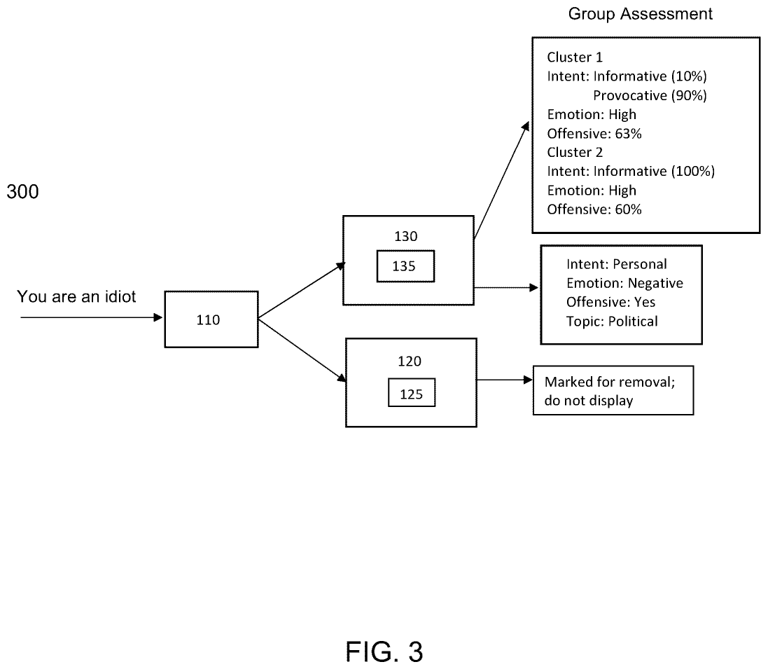

For example, FIG. 3 depicts a graphic functional diagram of an operation of a multilingual moderation system of the present principles, such as the multilingual moderation system 100 of FIG. 1, for example, during a communication session 300. In the embodiment of FIG. 3, an English-language phrase, “You are an idiot”, is received at the language module 110. The language module 110 determines, as described above, at least one classification for the English-language content and communicates the determined classification information for the phrase, “You are an idiot”, to the moderation control module 120 and to the reporting module 130, illustratively in parallel. As described above, at the moderation control module 120 the at least one classification determined for the English-language phrase, “You are an idiot”, at the language module 110 is analyzed, as described above, using a machine learning process of the present principles, such as the moderation machine learning process 125 of the moderation control module 120 depicted in FIG. 1, to determine if the received English-language phrase, “You are an idiot”, violates any moderation rules of the communication session 300. In the embodiment depicted in FIG. 3, the English-language phrase, “You are an idiot”, is marked for removal from the communication session 300 and, as such, the English-language phrase, “You are an idiot”, must violate a rule of the communication session as determined using the at least one classification determined by the language module 110 for the English-language phrase, “You are an idiot”.

As depicted in the embodiment of FIG. 3, the reporting module 130 can be used to report to at least one user, at least one of the the classification information determined for the received/acquired content data and/or semantic characteristics of the content data. In some embodiments and as further depicted in FIG. 3, a reporting module of the present principles, such as the reporting module 130 can keep track of and store moderation information and semantic information for some, if not all of the participants (e.g., content providers) of a communication session, such as the communication session 300 of FIG. 3. For example, in the embodiment of FIG. 3, classification information and/or semantic characteristics determined for multilingual content provided by more than one participant of a communication session can be presented in group form. That is, in some embodiments of the present principles and as depicted in FIG. 3, classification information and/or semantic characteristics of the content data provided by several posters/participants to a communication session can be combined and presented to at least one participant of the communication session as classification information of data content for the group (i.e., group level assessment). In such embodiments, users are able to determine how individual groups are doing with respect to a classification and/or specific semantic characteristics of content data, for example, how a group is doing with respect to offensive content.

In some embodiments of the present principles, a multilingual moderation system of the present principles, such as the multilingual moderation system 100 of FIG. 1, can implement a clustering approach to separate participants of a communication system into clusters of content data posters with similar agendas and/or intents. The multilingual moderation system of the present principles can then use the content data of one of the content posters in the cluster as representative of the cluster and thus determine a cluster wise characterization of classifications of the cluster. In some embodiments of the present principles, clustering can be performed using ChatGPT or GPT.5 techniques. In such embodiments of the present principles, participants of a communication session can be clustered based on semantic parameters/characteristics of respective content data (i.e., semantic parameters/characteristics of at least one classification determined for the content data) posted by each of the participants.

In alternate embodiments of the present principles, classifications for received/acquired data content are not determined by a language model as in the embodiment of the present principles described above. In such embodiments, the language module 110 can determine a language of the received multilingual content data. If it is determined by the language module 110 that the language of the content data is English, the content data can be forwarded to the moderation control module 110. Alternatively, if it is determined by the language module 110 that the language of the content data is other than English, the language module 110 can process the data to convert the received content data to English language equivalent data.

For example, in some embodiments of the present principles, in a first training stage, the language machine learning system 115 of the language module 110 can be trained to recognize a language of received data content. That is, in some embodiments, the language module 110 can receive content data having labels identifying the language of the received content data. The labeled content data received by the language module 110 can be used to train the language machine learning system 115 to recognize/detect and distinguish between various languages of received content data.

In some embodiments, a language machine learning system of the present principles, such as the language machine learning system 115 of the language module 110 of FIG. 1, can include a multi-layer neural network comprising nodes that are trained to have specific weights and biases. In some embodiments, the language machine learning system 115 employs artificial intelligence techniques or machine learning techniques to analyze received data content to identify a language of the received data content. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data content.

As described above, in a first training stage, the language machine learning system 115 of the language module 110 of FIG. 1 can be trained using a plurality (e.g., hundreds, thousands, millions, etc.) of instances of labeled content data in which the training data comprises a plurality of labeled content data to train a multilingual language learning model/algorithm of the present principles to recognize/detect and distinguish between various languages of received data content.

In some embodiments, in a second training stage, the language machine learning system 115 of the language module 110 of FIG. 1 can be trained to convert received non-English content data to English-equivalent content data. That is, in some embodiments, the language machine learning system 115 can be trained, in a second training stage, using a plurality (e.g., hundreds, thousands, millions, etc.) of instances of content data labeled to identify English content data and equivalents to the English content data in foreign languages.

For example, and referring back to the second training stage 200 of FIG. 2 described above, in this embodiment the language machine learning system 115 also includes a multilingual language learning model/algorithm 220. The multilingual language learning model/algorithm 220 receives English-language data content 205 (e.g., English-language words and/or phrases) and substantially equivalent foreign-language data content 210 (e.g., Foreign-language words and/or phrases). The multilingual language learning model/algorithm 220 embeds the received English-language data content 205 and the substantially equivalent foreign-language data content 210 into a common embedding space 230 in which words and/or phrases in different languages that are substantially the same occur closer to each other in the embedding space 230, and non-similar words and phrases are further apart in the embedding space 230.

In some embodiments, such as the embodiment depicted in FIG. 2, substantially equivalent phrases in different languages can appear to not be in the exact same location in the embedding space 230 because the words in the different language phrases are not exact translations. Instead, in such embodiments, what is being translated are the sentiment/semantics of the phrases and not the words.

Alternatively, in some embodiments, and as described above, a language module of the present principles, such as the language module 110 of FIG. 1, does not include the optional language machine learning system 115. Instead, in such embodiments, a language module of the present principles can include a pre-trained multilingual language model (not shown), such as XLM-RoBERTa.

Once the language machine learning system of the present principles, such as the language machine learning system 115, is trained or by implementation of the pre-trained multilingual language model, the language module of the present principles, such as the language module 110 of FIG. 1, can be used to determine a language of received content data and to convert foreign-language content data into English-language equivalent content data. That is, using the trained language machine learning system 115 or a pretrained multilingual language model as described above, a language module of the present principles, such as the language module 110 of FIG. 1, forwards English content data and/or English equivalent content data to a moderation control module of the present principles, such as the moderation control module 120 of FIG. 1.

At the moderation control module 120, received content data is evaluated to determine if the data should or should not be allowed, for example, to be posted on a social media site. In some embodiments of the present principles, the moderation machine learning system 125 of the moderation control module 120 can be trained to recognize content data that violates moderation policies for a particular application and as such should not be allowed/presented.

Because the content data received by the moderation control module 120 from the language module 110 is always in English, despite the language of origin of received content data at the language module 110, the moderation machine learning system 125 of the moderation control module 120 can be trained using English training data. Such “English-only” training enables the entire system of the present principles, such as the multilingual moderation system 100 of FIG. 1, to be scalable and tractable since the complexity of the system remains independent of the number of languages. Furthermore, English language content is plentiful and easily available which makes the training of the moderation machine learning system 125 much simpler compared to that required for full multilingual training with multiple languages.

In some embodiments of the present principles, the moderation machine learning system 125 of the moderation control module 120 can be trained to recognize data content that violates moderation rules and as such should not be presented. That is, in some embodiments, the moderation control module 120 can receive content data having labels identifying content data that has been deemed by a human moderator as complying with moderation rules and having labels identifying content data that does not comply with moderation rules for a specific platform (e.g., application). The labeled content data received by the moderation control module 120 can be used to train the moderation machine learning system 125 to recognize/detect and distinguish between content data that complies with moderation rules and content data the violates moderation rules for a specific platform.

In some embodiments, the moderation machine learning system 125 can include a multi-layer neural network comprising nodes that are trained to have specific weights and biases. In some embodiments, the moderation machine learning system 125 employs artificial intelligence techniques or machine learning techniques to analyze received data content to identify whether or not the data content complies with moderation rules. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data content.

As described above, during training, the moderation machine learning system 125 of the moderation control module 120 can be trained using a plurality (e.g., hundreds, thousands, millions, etc.) of instances of labeled content data identifying content data that complies with moderation rules and content data that violates moderation rules to train a moderation machine learning system of the present principles, such as the moderation machine learning system 125 of the moderation control module 120, to recognize/detect and distinguish between data content that complies with moderation rules and data content that does not comply with moderation rules of a specific platform. Moderation machine learning systems of the present principles can be trained, as described above, for a plurality of platforms having respective rules.

In some embodiments of the present principles, a moderation control module of the present principles, such as the moderation control module 120 of FIG. 1, can provide information about which moderation guidelines were violated by particular content data. In some embodiments, the moderation control module 120 of the multilingual moderation system 100 of FIG. 1 can represent a moderation guideline being violated as a latent variable h and model the probability distribution of output as a conditional distribution PP(yy|xx, h), where yy represents the output and xx represents the content data. In some embodiments, the probability distribution PP(yy|xx, h) can be modeled as another linear layer on top of the moderation machine learning system/model 125 the moderation control module 120. In some embodiments of the present principles, the training of the moderation machine learning system/model 125 is converted into an inference-based learning problem and expectation-maximization can be used to learn the moderation machine learning system/model 125. As a result, the moderation machine learning system/model 125 can flag data content as complying with moderation rules or not and also provide insight into the moderation guideline being violated. Alternatively or in addition, in some embodiments, the moderation machine learning system/model 125 can be trained to recognize which moderation guidelines have been violated using training data including labeled content data having information as to which moderation guidelines are violated by the labeled content data.

Once trained, a moderation machine learning system of the present principles, such as the moderation machine learning system 125 of the moderation control module 120 of FIG. 1, can be used to determine if received content data violates moderation rules to determine if the content data received from, for example a content poster on a social media platform, should be presented, for example, to another user of the social media platform.

In some embodiments of the present principles, the processed content data from the language module 110 can be communicated directly or through the moderation control module 120 to the optional reporting module 130. The reporting module 130 can determine several parameters of received content data to, for example, include in a presentation to be presented to at least a provider of the content data and/or an intended receiver of the content data.

For example, and referring back to FIG. 3, as described above, FIG. 3 depicts a graphic functional diagram of an operation of a multilingual moderation system of the present principles, such as the multilingual moderation system 100 of FIG. 1 during a communication session 300. In the embodiment of FIG. 3, an English-language phrase, “You are an idiot”, is received at the language module 110. The language module 110 determines, as described above, that the received content data is in English and communicates the English-language phrase, “You are an idiot”, to the moderation control module 120 and to the reporting module 130, illustratively in parallel. As described above, at the moderation control module 120 the English-language phrase, “You are an idiot”, is analyzed, as described above, using a machine learning process of the present principles, such as the moderation machine learning process 125 of the moderation control module 120 depicted in FIG. 1, to determine if the received English-language phrase, “You are an idiot”, violates any moderation rules of the session 300. In the embodiment depicted in FIG. 3, the English-language phrase, “You are an idiot”, is marked for removal from the communication session 300 and, as such, the English-language phrase, “You are an idiot”, must violate a rule of the communication session.

In this embodiment of FIG. 3, the reporting module 130 includes a semantics machine learning system 135 to determine several parameters of the received content data illustratively including, but not limited to, an intent of the received English-language phrase, “You are an idiot”, an emotion of the English-language phrase, a determination as to whether or not the English-language phrase, is offensive, and a topic of the English-language phrase, “You are an idiot”, an abuse level of the English-language phrase, “You are an idiot”, and/or an overall topic of the communication session 300. In the embodiment of FIG. 3, the intent of the received English-language phrase, “You are an idiot”, is determined to be Personal, the emotion of the received English-language phrase has been determined to be negative, the English-language phrase has been determined to be offensive, and the topic of the communication session 300 has been determined to be political.

A semantics machine learning system of the present principles, such as the semantics machine learning system 135 of the reporting module 130, can be trained to identify semantic parameters/characteristics in received multilingual content data, including but not limited to an intent of multilingual content data, an emotion of the multilingual content data, a determination as to whether or not the multilingual content data is offensive, and a topic of the multilingual content data. More specifically, a semantics machine learning system of the present principle can be trained using a plurality (e.g., hundreds, thousands, millions, etc.) of instances of labeled content data identifying semantic parameters/characteristics of content data including, but not limited to an intent of multilingual content data, an emotion of the multilingual content data, a determination as to whether or not the multilingual content data is offensive, and a topic of the multilingual content data to train a semantics machine learning system of the present principles, such as the semantics machine learning system 135 of the reporting module 130 to recognize/detect and identify semantic parameters/characteristics in received multilingual data content.

In some embodiments, a semantics machine learning system of the present principles, such as the semantics machine learning system 135 of the reporting module 130 can include a multi-layer neural network comprising nodes that are trained to have specific weights and biases. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data content.

As depicted in the embodiment of FIG. 3, in some embodiments, a reporting module of the present principles, such as the reporting module 130 can keep track of and store moderation information and semantic information for some, if not all of the participants (e.g., content providers) of a communication session, such as the communication session 300 of FIG. 3. For example, in the embodiment of FIG. 3, semantic parameters/characteristics determined for multilingual content provided by more than one participant of a communication session can be presented in group form. That is, in some embodiments of the present principles and as depicted in FIG. 3, semantic parameters/characteristics of the content data provided by several posters/participants to a communication session can be combined and presented to at least one participant of the communication session as semantic parameters/characteristics for the group (i.e., group level assessment).

For example, in some embodiments of the present principles, a multilingual moderation system of the present principles, such as the multilingual moderation system 100 of FIG. 1, can implement a clustering approach to separate participants of a communication system into clusters of content data posters with similar agendas and/or intents. The multilingual moderation system of the present principles can then use the content data of one of the content posters in the cluster as representative of the cluster and thus determine a cluster wise characterization of semantic parameters/characteristics of the cluster. In some embodiments of the present principles, clustering can be performed using ChatGPT or GPT.5 techniques.

Once trained, a semantics machine learning system of the present principles, such as the semantics machine learning system 135 of the reporting module 130 can be used to determine semantic parameters/characteristics of received multilingual content data. In some embodiments, the determined semantic information can be presented to at least one of a creator of the multilingual content or at least one other participant of the communication session 300.

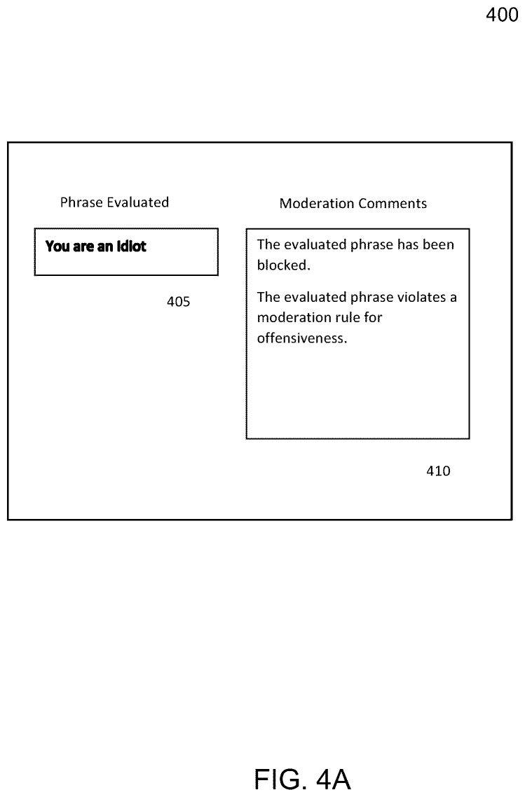

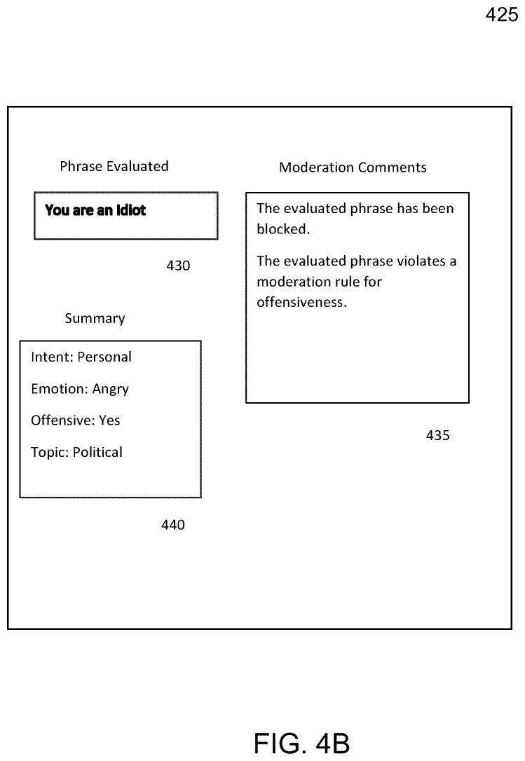

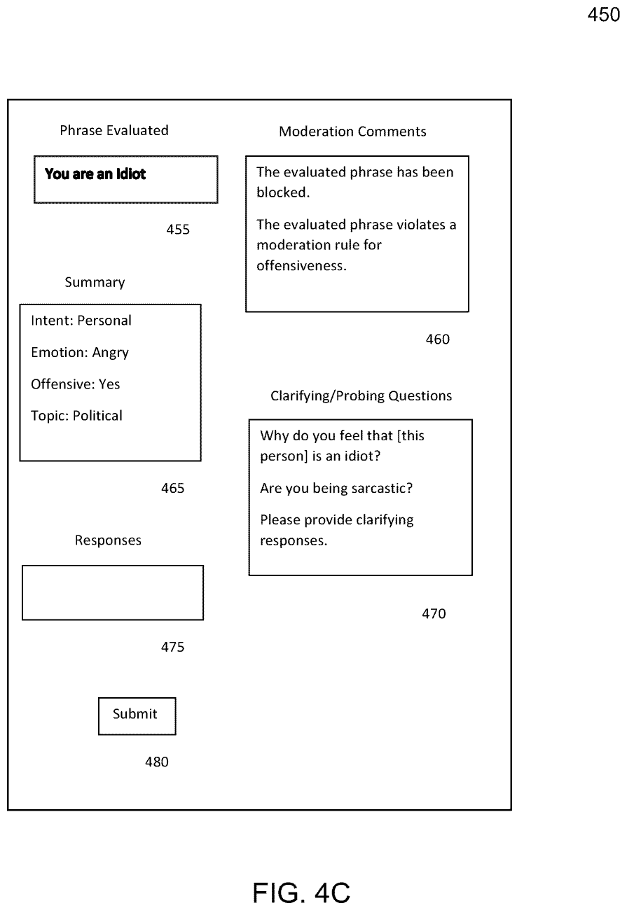

FIG. 4A depicts a graphic representation of a first embodiment of a graphical user interface (GUI) 400 which can be implemented to communicate with a user of a multilingual moderation system of the present principles, such as the multilingual moderation system 100 of FIG. 1. In the embodiment of FIG. 4A, the GUI 400 can be implemented to inform a user as to which content data phrase is being evaluated, illustratively in a first display section 405 (Phrase Evaluated section) of the GUI 400. In the embodiment of FIG. 4A, a second display section 410 (Moderation Comments section) is implemented to inform a user as to whether or not the evaluated phrase has been prohibited/blocked and a reason for prohibiting/blocking the phrase.

FIG. 4B depicts a graphic representation of a second embodiment of a graphical user interface (GUI) 425 which can be implemented to communicate with a user of a multilingual moderation system of the present principles, such as the multilingual moderation system 100 of FIG. 1. In the embodiment of FIG. 4B, the GUI 425 also includes a first display section 430 (Phrase Evaluated section) to inform a user as to which content data phrase is being evaluated, a second display section 435 (Moderation Comments section) to inform a user as to whether or not the evaluated phrase has been prohibited/blocked and a reason for prohibiting/blocking the phrase, and also includes a third display section 440 (Summary section) to inform a user of classifications/semantic parameters/characteristics determined for the content data phrase being evaluated. In the embodiment of FIG. 4B, the third display section 440 (Summary section) can inform a user of an intent of the phrase being evaluated, an emotion of the phrase being evaluated, an offensiveness of the phrase being evaluated, an abuse level of the phrase being evaluated, a topic of the phrase being evaluated and the like. For example, in the embodiment of FIG. 4B, the third display section (Summary section) of the GUI 425 informs the user that the intent of the phrase being evaluated has been determined to be Personal, the emotion of the phrase being evaluated has been determined to be angry, the phrase being evaluated has been determined to be offensive, and the topic of the communication (not shown) from which the phrase being evaluated was selected has been determined to be political.

FIG. 4C depicts a graphic representation of a third embodiment of a graphical user interface (GUI) 450 which can be implemented to communicate with a user of a multilingual moderation system of the present principles, such as the multilingual moderation system 100 of FIG. 1. In the embodiment of FIG. 4C, the GUI 450 also includes a first display section 455 (Phrase Evaluated section) to inform a user as to which content data phrase is being evaluated, a second display section 460 (Moderation Comments section) to inform a user as to whether or not the evaluated phrase has been prohibited/blocked and a reason for prohibiting/blocking the phrase, and a third display section 465 (Summary section) to inform a user of classifications/semantic parameters/characteristics determined for the content data phrase being evaluated, such as an intent of the phrase being evaluated, an emotion of the phrase being evaluated, an offensiveness of the phrase being evaluated, an abuse level of the phrase being evaluated, a topic of the phrase being evaluated and the like. In the embodiment of FIG. 4C, the GUI 450 also includes a fourth display section 470 (Clarifying/Probing Questions section) to request additional information from a user, and a fifth display section 475 (Responses section) to enable a user to input information in response to the information requested. After inputting the information in the fifth display section 475 of the GUI 450, the user can submit the information using the submit button 480.

In the embodiment of FIG. 4C, clarifying questions of “Why do you feel that [this person] is an idiot?” and “Are you being sarcastic?” are posed to a user of the GUI 450 of a multilingual moderation system of the present principles. In some embodiments of the present principles, the clarifying questions are intended to solicit information from a user that can assist in determining if the at least one classification and/or semantic characteristics previously determined for the phrase being evaluated are accurate. For example, if a user response indicates that in the phrase being evaluated, the user was being sarcastic, such information can be communicated back to, for example, a language module of the present principles, such as the language module 110 of FIG. 1, to assist the language module in determining at least one classification and/or semantic characteristics for the phrase being evaluated as described above.

In some embodiments of the present principles, clarifying/probing questions of the present principles can be predetermined and stored in a storage device (not shown) accessible to at least one of the language module 110, the moderation control module 120 and/or the reporting module 130 of, for example the multilingual moderation system 100 of FIG. 1, such that the clarifying/probing questions can be presented to a user in a GUI of the present principles, such as the GUI 450 of FIG. 4C.

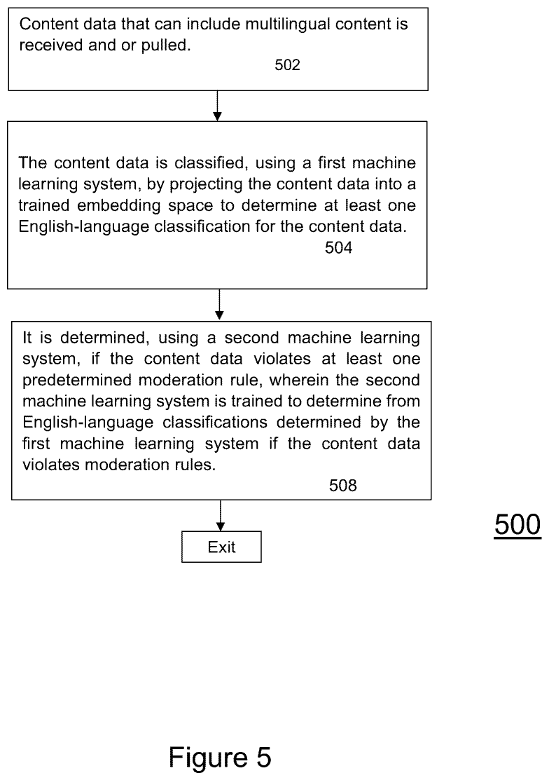

FIG. 5 depicts a flow diagram of a method for moderating multilingual content data, for example, presented during a communication session. The method 500 of FIG. 5 can begin at 502 during which content data that can include multilingual content, for example, generated by participants of the communication session, is received and or pulled (acquired). The method 500 can proceed to 504.

At 504, the content data is classified, using a first machine learning system, by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar. The method 500 can proceed to 506.

At 506, it is determined, using a second machine learning system, if the content data violates at least one predetermined moderation rule, wherein the second machine learning system is trained to determine from English-language classifications determined by the first machine learning system if the content data violates moderation rules. The method 500 can be exited.

In some embodiments, the method can further include prohibiting a presentation of the content data related to the at least one English-language classification determined to violate the at least one predetermined moderation rule.

In some embodiments the method can further include presenting semantic parameters related to the determined at least one English-language classification to at least one participant of the communication session.

In some embodiments, the semantic parameters include at least one of an intent of the received or pulled content data, an emotion of the received or pulled content data, an offensiveness of the received or pulled content data, an abuse level of the received or pulled content data, or a topic of the received or pulled content data.

In some embodiments of the present principles, the content data includes English-language content data and the at least one English-language classification is determined for the English-language content data using the English language content data.

In some embodiments of the present principles, the content data comprises non-English-language content data and similar English-language content data is determined for the non-English-language content data by projecting the non-English-language content data into the embedding space and at least one English-language classification is determined for the non-English-language content data using the determined similar English language content data.

In some embodiments of the present principles, the content data is presented during a communication session and the method further includes clustering participants of the communication session based on semantic characteristics of respective content data posted to the communication session by each of the participants.

In some embodiments of the present principles, the method can further include soliciting information from at least one source of the received or pulled content data to assist in determining an accuracy of the at least one English-language classification determined for the received or pulled content data.

As depicted in FIG. 1, embodiments of a multilingual moderation system of the present principles, such as the multilingual moderation system 100 of FIG. 1, can be implemented in a computing device 600. That is, in some embodiments content data from, for example, social media posts can be communicated to a multilingual moderation system of the present principles using the computing device 600 via, for example, any input/output means associated with the computing device 600. Semantic parameters/characteristics and moderation decisions determined by a multilingual moderation system of the present principles, such as the multilingual moderation system 100 of FIG. 1, can be presented to a poster of the content data and/or another participant in a communication session in which the content data was posted using an output device of the computing device 600, such as a display, a printer or any other form of output device of the computing device 600 or any other presentation device associated with the poster of the content data and/or another participant in a communication session in which the content data was posted.

For example, FIG. 6 depicts a high-level block diagram of a computing device 600 suitable for use with embodiments of a multilingual moderation system of the present principles, such as the multilingual moderation system 100 of FIG. 1. In the embodiment of FIG. 6, the computing device 600 includes one or more processors 610a-610n coupled to a system memory 620 via an input/output (I/O) interface 630. The computing device 600 further includes a network interface 640 coupled to I/O interface 630, and one or more input/output devices 650, such as cursor control device 660, keyboard 670, and display(s) 680. In various embodiments, a user interface can be generated and displayed on display 680. In some cases, it is contemplated that embodiments can be implemented using a single instance of a computing device 600, while in other embodiments multiple such systems, or multiple nodes making up the computing device 600, can be configured to host different portions or instances of various embodiments. For example, in one embodiment some elements can be implemented via one or more nodes of the computing device 600 that are distinct from those nodes implementing other elements. In another example, multiple nodes may implement the computing device 600 in a distributed manner.

In different embodiments, the computing device 600 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 600 can be a uniprocessor system including one processor 610, or a multiprocessor system including several processors 610 (e.g., two, four, eight, or another suitable number). Processors 610 can be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 can be configured to store program instructions 622 and/or, in some embodiments, machine learning systems that are accessible by the processor 610. In various embodiments, system memory 620 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 620. In other embodiments, program instructions and/or data can be received, sent or stored upon different types of computer-accessible media or on similar media separate from the system memory 620 or the computing device 600.

In one embodiment, I/O interface 630 can be configured to coordinate I/O traffic between processor 610, system memory 620, and any peripheral devices in the device, including network interface 640 or other peripheral interfaces, such as input/output devices 650. In some embodiments, I/O interface 630 can perform any necessary protocol, timing or other data transformations to convert data signals from one component (e.g., system memory 620) into a format suitable for use by another component (e.g., processor 610). In some embodiments, I/O interface 630 can include support for devices attached through various types of peripheral buses, such as a variant of the Peripheral Component Interconnect (PCI) bus standard or the Universal Serial Bus (USB) standard, for example. In some embodiments, the function of I/O interface 630 can be split into two or more separate components, such as a north bridge and a south bridge, for example. Also, in some embodiments some or all of the functionality of I/O interface 630, such as an interface to system memory 620, can be incorporated directly into processor 610.

Network interface 640 can be configured to allow data to be exchanged between the computing device 600 and other devices attached to a network (e.g., network 690), such as one or more external systems or between nodes of the computing device 600. In various embodiments, network 690 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 650 can, in some embodiments, include one or more display terminals, keyboards, keypads, touchpads, scanning devices, voice or optical recognition devices, or any other devices suitable for entering or accessing data by one or more computer systems. Multiple input/output devices 650 can be present in computer system or can be distributed on various nodes of the computing device 600. In some embodiments, similar input/output devices can be separate from the computing device 600 and can interact with one or more nodes of the computing device 600 through a wired or wireless connection, such as over network interface 640.

Those skilled in the art will appreciate that the computing device 600 is merely illustrative and is not intended to limit the scope of embodiments. In particular, the receiver/control unit and peripheral devices can include any combination of hardware or software that can perform the indicated functions of various embodiments, including computers, network devices, Internet appliances, PDAs, wireless phones, pagers, and the like. The computing device 600 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 600 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 600 is depicted as a general purpose computer, the computing device 600 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

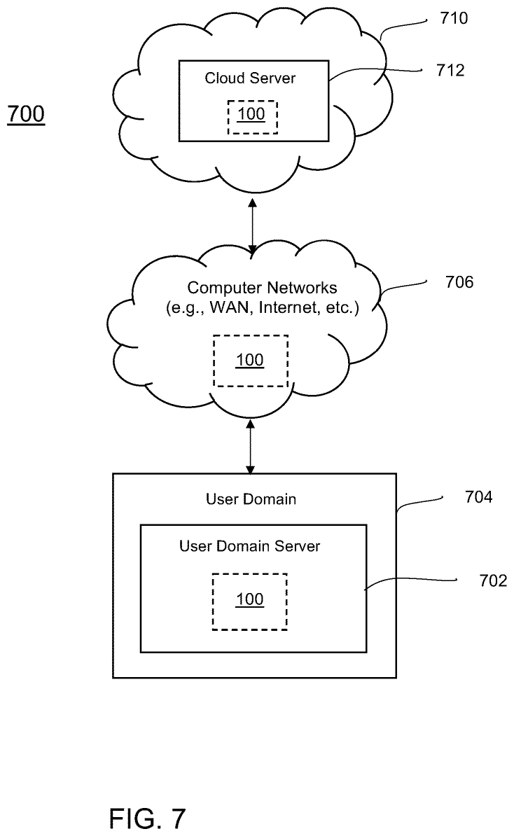

FIG. 7 depicts a high-level block diagram of a network in which embodiments of a multilingual moderation system in accordance with the present principles, such as the multilingual moderation system 100 of FIG. 1, can be implemented. The network environment 700 of FIG. 7 illustratively comprises a user domain 702 including a user domain server/computing device 704. The network environment 700 of FIG. 7 further comprises computer networks 706, and a cloud environment 710 including a cloud server/computing device 712.

In the network environment 700 of FIG. 7, a multilingual moderation system in accordance with the present principles, such as the multilingual moderation system 100 of FIG. 1, can be included in at least one of the user domain server/computing device 704, the computer networks 706, and the cloud server/computing device 712. That is, in some embodiments, a user can use a local server/computing device (e.g., the user domain server/computing device 704) to provide moderation and provide semantic parameters/characteristics of multilingual content data in accordance with the present principles. In some embodiments, a user can implement a multilingual moderation system in accordance with the present principles, such as the multilingual moderation system 100 of FIG. 1 in the computer networks 706 to provide moderation and provide semantic parameters/characteristics of multilingual content data in accordance with the present principles. Alternatively or in addition, in some embodiments, a user can provide a multilingual moderation system of the present principles in the cloud server/computing device 712 of the cloud environment 710. For example, in some embodiments it can be advantageous to perform processing functions of the present principles in the cloud environment 710 to take advantage of the processing capabilities and storage capabilities of the cloud environment 710.

In some embodiments in accordance with the present principles, an imaging and control system in accordance with the present principles can be located in a single and/or multiple locations/servers/computers to perform all or portions of the herein described functionalities of a system in accordance with the present principles. For example, in some embodiments some components of the multilingual moderation system of the present principles can be located in one or more than one of the user domain 702, the computer network environment 706, and the cloud environment 710 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from a computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present principles, other and further embodiments of the invention may be devised without departing from the basic scope thereof, and the scope thereof is determined by the claims that follow.

1. A method for moderating multilingual content data, comprising:
receiving or pulling content data that can include multilingual content;
classifying, using a first machine learning system, the content data by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar; and
determining, using a second machine learning system, if the content data violates at least one predetermined moderation rule, wherein the second machine learning system is trained to determine from English-language classifications determined by the first machine learning system if the content data violates moderation rules.

2. The method of claim 1, further comprising:
prohibiting a presentation of the content data related to the at least one English-language classification determined to violate the at least one predetermined moderation rule.

3. The method of claim 1, wherein the content data is presented during a communication session, the method further comprising:
presenting semantic parameters related to the determined at least one English-language classification to at least one participant of the communication session.

4. The method of claim 3, wherein the semantic parameters related to the determined at least one English-language classification include at least one of an intent of the received or pulled content data, an emotion of the received or pulled content data, an offensiveness of the received or pulled content data, an abuse level of the received or pulled content data, or a topic of the received or pulled content data.

5. The method of claim 1, wherein the content data comprises English-language content data and wherein at least one English-language classification is determined for the English-language content data using the embedding of the English-language content data.

6. The method of claim 1, wherein the content data comprises non-English-language content data and similar English-language content data is determined for the non-English-language content data by projecting the non-English-language content data into the embedding space, and wherein at least one English-language classification is determined for the non-English-language content data using the determined similar English language content data.

7. The method of claim 1, wherein the content data is presented during a communication session and the method further comprises:
clustering participants of the communication session based on semantic characteristics of respective content data posted to the communication session by each of the participants.

8. The method of claim 1, further comprising:
soliciting information from at least one source of the received or pulled content data to assist in determining an accuracy of the at least one English-language classification determined for the received or pulled content data.

9. An apparatus for moderating multilingual content data, comprising:
a processor; and
a memory accessible to the processor, the memory having stored therein at least one of programs or instructions executable by the processor to configure the apparatus to:
receive or pull content data that can include multilingual content;
classify, using a first machine learning system, the content data by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar; and
determine, using a second machine learning system, if the content data violates at least one predetermined moderation rule, wherein the second machine learning system is trained to determine from English-language classifications determined by the first machine learning system if the content data violates moderation rules.

10. The apparatus of claim 9, wherein the apparatus is further configured to:
prohibit a presentation of the content data related to the at least one English-language classification determined to violate the at least one predetermined moderation rule.

11. The apparatus of claim 9, wherein the content data is presented during a communication session, the apparatus is further configured to:
present semantic parameters related to the determined at least one English-language classification to at least one participant of the communication session.

12. The apparatus of claim 11, wherein the semantic parameters related to the determined at least one English-language classification include at least one of an intent of the received or pulled content data, an emotion of the received or pulled content data, an offensiveness of the received or pulled content data, an abuse level of the received or pulled content data, or a topic of the received or pulled content data.

13. The apparatus of claim 9, wherein the content data comprises English-language content data and wherein at least one English-language classification is determined for the English-language content data using the embedding of the English-language content data.

14. The apparatus of claim 9, wherein the content data comprises non-English-language content data and similar English-language content data is determined for the non-English-language content data by projecting the non-English-language content data into the embedding space, and wherein at least one English-language classification is determined for the non-English-language content data using the determined similar English language content data.

15. The apparatus of claim 9, wherein the content data is presented during a communication session and the apparatus is further configured to:
cluster participants of the communication session based on semantic characteristics of respective content data posted to the communication session by each of the participants.

16. The apparatus of claim 9, wherein the apparatus is further configured to:
solicit information from at least one source of the received or pulled content data to assist in determining an accuracy of the at least one English-language classification determined for the received or pulled content data.

17. A non-transitory computer readable storage medium having stored thereon instructions that when executed by a processor perform a method for moderating multilingual content data, the method comprising:
receiving or pulling content data that can include multilingual content;
classifying, using a first machine learning system, the content data by projecting the content data into a trained embedding space to determine at least one English-language classification for the content data, wherein the embedding space is trained such that embedded English-language content data and embedded non-English-language content data that are similar occur closer in the embedding space than embedded English-language content data and embedded non-English-language content data that are not similar; and
determining, using a second machine learning system, if the content data violates at least one predetermined moderation rule, wherein the second machine learning system is trained to determine from English-language classifications determined by the first machine learning system if the content data violates moderation rules.

18. The non-transitory computer readable storage medium of claim 17, further comprising:
prohibiting a presentation of the content data related to the at least one English-language classification determined to violate the at least one predetermined moderation rule.

19. The non-transitory computer readable storage medium of claim 17, wherein if the content data comprises English-language content data, at least one English-language classification is determined for the English-language content data using the embedding of the English-language content data and wherein if the content data comprises non-English-language content data, similar English-language content data is determined for the non-English-language content data by projecting the non-English-language content data into the embedding space, and at least one English-language classification is determined for the non-English-language content data using the determined similar English language content data.

20. The non-transitory computer readable storage medium of claim 17, further comprising:
soliciting information from at least one source of the received or pulled content data to assist in determining an accuracy of the at least one English-language classification determined for the received or pulled content data.
